(19) United States
(12) Patent Application Publication
(10) Pub. No.: US 2008/0110246 A1
(43) Pub. Date: May 15, 2008

(54) CAPILLARY RHEOMETER WITH INSTRUMENTED CLEANING AND PACKING DEVICE

(76) Inventors: Barry Ward Old, Wilmington, NC (US); Robert C. Phillips, Wilmington, NC (US); Jane Old, Wilmington, NC (US)

Correspondence Address: Alvin T. Rockhill, P.O. Box 1283, Bath, OH, 44210-1283, US

(21) Appl. No.: 11/551,153

(22) Filed: Oct. 19, 2006

(51) Int. Cl. G01N 11/04

(52) U.S. Cl. 73/54.11

(57) ABSTRACT

The present invention is a capillary rheometer cleaning and packing device comprising: (a) a linear motion device for creating controlled linear motion in a linear motion rod, wherein the linear motion rod is adapted to receive a cleaning/packing rod; (b) a housing securing means wherein the securing means is adapted to secure an existing capillary rheometer housing to the cleaning and packing device such that a barrel mounted concentrically within the capillary rheometer housing is positioned coaxially below the linear motion rod; and (c) a means of attaching the capillary rheometer cleaning and packing apparatus to an existing capillary rheometer.

### BACKGROUND OF THE INVENTION

Various types of capillary rheometers are used to determine the shear and temperature related properties of polymeric materials. Capillary rheometers generally operate by using a plunger to force molten polymers such as plastics that have been heated in a barrel passage through a capillary die. The plunger applies a consistent pressure to force the melted polymer through the die. Various types of pressure transducers are utilized in existing capillary rheometers to measure and monitor the pressure applied by the plunger. A displacement sensor measures the plunger velocity through the barrel so that the shear viscosity of the melted polymer can be determined using known relationships for flow of polymer melts through cylindrical or other commonly used geometries.

U.S. Pat. No. 3,203,225 discloses a capillary extrusion rheometer. More specifically, U.S. Pat. No. 3,203,225 discloses an extrusion capillary rheometer comprising a furnace containing a removable barrel; said barrel containing an open cylinder and means for removably affixing a capillary fitting concentric with said cylinder; said capillary fitting having a capillary opening concentric with said cylinder and provided with means for positioning a temperature sensing element in close proximity to at least a portion of said capillary opening; a piston reciprocally movable within said cylinder and capable of being completely removed therefrom for case in inserting a thermoplastic material within said cylinder; a power source attached through a drive shaft and an electronic pressure sensing element to said piston at its driven end; said pressure sensing element being instantaneously responsive to the force exerted by said source in forcing said thermoplastic material through the capillary opening; an electronic velocity sensing element affixed to said drive shaft and instantaneously responsive to the velocity at which the drive shaft moves the piston forcing the thermoplastic material through the capillary opening; and a source of electrical energy interconnected with said pressure sensing element and said velocity sensing element; said sensing elements being responsive to rapid minute changes in pressure and velocity, respectively.

U.S. Pat. No. 5,209,107 discloses a capillary rheometer apparatus for generating information on the compressibility of materials, comprising: a housing; a plunger; said housing having passage means for receiving said plunger and means contiguous with said passage means for blocking flow out of said housing; means for driving said plunger longitudinally within said passage means to move one end of said plunger towards said means for blocking; said plunger having means defining a liquid-filled capillary passage extending therein from said one end of said plunger; a coupler at said one end of said plunger defining with said plunger a chamber in communication with said capillary passage and for sensing pressure in said passage means and transmitting said pressure to said liquid fill; and means coupled from said capillary passage responsive to pressure exerted by said liquid fill for providing an indication of sensed pressure.

U.S. Pat. No. 5,258,601 discloses a capillary rheometer comprising: (a) a furnace comprising a plurality of furnace zones so arranged as to suppress mutual thermal interference and provided with a central sample bore into which a sample to be tested is inserted, and a capillary connected to the lower end of said central sample bore; (b) a plurality of heaters each provided for one of said furnace zones to heat said sample in said sample bore; (c) plunger means for imposing a predetermined load on said heated sample to extrude the same through said capillary; (d) a plurality of temperature sensors each provided in one of said furnace zones for measuring the temperatures thereof; (e) means for storing the temperature characteristics of said furnace zones related to the temperature of the inner wall of said sample bore; (f) means for setting a reference value of the temperature of said inner wall of said sample bore; (g) heater controlling means for determining on the basis of said temperature characteristics stored in said storing means the temperature of each said furnace zones corresponding to said set reference temperature value, and controlling energization of said heaters so that the temperature detected by each of said temperature sensors coincides with said determined temperature of the corresponding one of said furnace zones, whereby the sample is uniformly heated.

A clean capillary rheometer is essential for precise and accurate measurements. The rheometer is normally cleaned before testing of all experimental polymer samples. There are various known methods of cleaning a capillary rheometer. One such method is to clean the barrel, plunger, and capillary die with a suitable solvent. For high viscosity polymers it is sometimes necessary to do so under vacuum. In cases where this method is utilized it is often necessary to allow polymer residue to soak in the solution for an extended period of time. The cleaned parts must also be allowed to thoroughly dry before subsequent use. Thus, this method of cleaning is extremely time-consuming and can result in the emission of volatile organic solvents into the atmosphere.

Another known method of cleaning polymer residue from a capillary rheometer involves baking the necessary components at high temperatures. In the case of this method the high temperatures of an oven are used to burn off the remaining residue. This method of cleaning the capillary rheometer is time consuming, and requires a high temperature oven suitable for burning of polymer residue. In addition, the capillary rheometer must be disassembled to allow the necessary components to be removed for baking. This method is thus both labor intensive and time consuming.

U.S. Pat. No. 4,587,837 discloses a device for measuring the rheometric properties of molten polymeric materials by expressing them through a capillary. In this process the barrel of the rheometer is surrounded by a plurality of electrical heating elements which are automatically controlled to maintain a constant temperature along the length of the barrel. A liner is situated to fit securely in the bore of the barrel for retaining polymeric samples. A disposable capillary tube having a capillary through which the polymeric sample is extruded by application of positive gas pressure above the sample is included in this design. This rheometer design also includes a capillary tube holder which fits in a sealing relationship between the liner and the capillary tube and a separate bottom plate which prevents the capillary tube from moving when the polymeric material is extruded through it. U.S. Pat. No. 4,587,837 reports that in using this device the liner, the capillary tube, and the tube holder can be readily removed and replaced by like components to facilitate quick sample changes and easy cleaning thereof. U.S. Pat. No. 4,587,837 also teaches that the cleaning of removable components may be accomplished by baking the components to burn off excess residue.

Yet another known method of cleaning polymer residue from the barrel of a capillary rheometer is by manually brushing the barrel with a cylindrical brush mounted on a rod to loosen the polymer residue and then swabbing the barrel with cloth patches to remove the loosened residue. The barrel brush is often attached to an electric motor which rotates the brush as it is manually moved vertically within the barrel. Although this cleaning method is faster than the other known methods because it does not require disassembly, baking time, drying time or cooling time, it is also difficult for the user of the rheometer to perform. Due to the position of most tabletop and stand-alone capillary rheometers it is difficult to manually clean the barrel from the top because of its height, requiring either awkward overhead reaching of the user or use of a stool or similar device. Also, the manual movement of the rod to brush or swab the barrel can be tiring physical labor, leading to partial or ineffective cleaning of the barrel.

Proper use of a capillary rheometer for effective testing and accurate data requires that the polymer powder being tested be uniformly packed into the barrel of the rheometer. Packing the polymer ensures that the polymer powder is distributed evenly throughout the barrel and allows for uniform heat distribution within the barrel during the melting of the polymer. One known method of packing the polymer into the rheometer involves the use of a manual lever arm to depress a packing rod in the barrel. This method, however, is burdensome and inconsistent. In light of the deficiencies of the aforementioned prior art methods of cleaning and packing a capillary rheometer, there exists a need for a capillary rheometer equipped with an apparatus that will provide quick, effective and efficient cleaning of the barrel between tests and consistent packing of the polymer within the barrel prior to testing.

### SUMMARY OF THE INVENTION

The capillary rheometer cleaning and packing device of the present invention includes a linear motion device mounted to a capillary rheometer. The linear motion device includes a linear motion rod wherein the linear motion rod is adapted to receive a cleaning and packing rod. The two rods are coaxially secured to one another such that the linear motion of the linear motion rod is transferred to the cleaning/packing rod. The cleaning/packing rod is adapted to be secured to a cleaning/packing tip opposite the linear motion rod so that the linear motion is also transferred to the cleaning/packing tip. After a test is performed with the capillary rheometer to determine thermal viscosity properties of a polymer, the capillary rheometer housing is moved to a cleaning position where the cleaning and packing device is used to clean the barrel of the capillary rheometer, and then to pack a polymer resin within the barrel for subsequent testing.

The cleaning and packing device includes a housing securing means to secure a capillary rheometer housing in the cleaning position, in which the barrel of the housing is positioned coaxially beneath the linear motion rod. The securing means ensures that the barrel will remain coaxially aligned with the cleaning/packing rod and tip during cleaning and packing. The cleaning and packing device of the present invention allows for quick and effective cleaning and packing of a capillary rheometer without a need for extensive baking, cooling, or drying time. The device of the present invention enables a user to clean and pack the capillary rheometer using only a small amount of manual labor.

The present invention more specifically discloses a capillary rheometer cleaning and packing device comprising: (a) a linear motion device for creating controlled linear motion in a linear motion rod, wherein the linear motion rod is adapted to receive a cleaning/packing rod; (b) a housing securing means wherein the securing means is adapted to secure an existing capillary rheometer housing to the cleaning and packing device such that a barrel mounted concentrically within the capillary rheometer housing is positioned coaxially below the linear motion rod; and (c) a means of attaching the capillary rheometer cleaning and packing apparatus to an existing capillary rheometer.

The present invention also discloses a capillary rheometer apparatus comprising: (a) a frame; (b) a housing having an outer shell, a barrel and a heating means wherein the barrel is located concentrically within the outer shell and wherein the heating means is located concentrically between the barrel and the outer shell and wherein the housing is movably mounted such that it may be moved to either a testing position or a cleaning position; (c) a capillary die contiguous with the barrel; (d) a plunger adapted to fit within the bore of the housing barrel; (e) a means for driving the plunger longitudinally within the bore of the housing barrel; (f) a means for sensing the pressure within the bore of the housing barrel and a means for providing an indication of the sensed pressure; (g) a means of securing the housing in the testing position; and (h) a cleaning and packing device comprising: (i) a linear motion device for creating controlled linear motion in a linear motion rod, wherein the linear motion rod is adapted to receive a cleaning/packing rod; and (ii) a means of securing the housing in the cleaning position such that the housing barrel is positioned coaxially below the linear motion rod; wherein the cleaning and packing device is affixed to the frame. The present invention further discloses a method of cleaning and packing a capillary rheometer apparatus comprising: (a) removing the capillary die secured to the bottom of the barrel; (b) securing the housing in a cleaning position wherein the barrel is positioned coaxially below the linear motion rod; (c) brushing the barrel with reciprocating motion provided by the linear motion device using a cleaning brush coaxially secured to a cleaning/packing rod, wherein the cleaning/packing rod is removably and coaxially secured to the linear motion rod; (d) cleaning the barrel with reciprocating motion provided by the linear motion device using a cloth patch cleaning tip coaxially secured to a cleaning/packing rod, wherein the cleaning/packing rod is removably and coaxially secured to the linear motion rod; (e) attaching the capillary die to the bottom of the barrel; (f) pouring a polymer resin into the barrel and packing the polymer resin with reciprocating motion provided by the linear motion device using a packing tip coaxially secured to a cleaning/packing rod, wherein the cleaning/packing rod is removably and coaxially secured to the linear motion rod, and wherein the polymer resin may be added and packed repeatedly as needed until the barrel is filled to the desired amount; and (g) moving the housing to and securing it in the testing position. It should be noted that the barrel can be cleaned with the cloth patch prior to cleaning it with the cleaning brush. In other words, step (d) can be conducted prior to step (c). The preferred order of cleaning the barrel with the cloth patch and the brush will be dependent upon the characteristics of the polymer being tested, the test conditions, and the preferences of the operator.

### BRIEF DESCRIPTION OF DRAWINGS

A more complete understanding of the invention and its advantages will be apparent from a review of the Detailed Description in conjunction with the following drawings, in which:

FIG. 1 is a front view of a conventional rheometer having the capillary rheometer cleaning and packing device attached thereto.

FIG. 2 is a side view of the capillary rheometer cleaning and packing device of this invention wherein the housing for the barrel passage and the capillary die is situated below the cleaning and packing device (in the cleaning/packing position).

FIG. 3 is a cross sectional view of the housing for the barrel passage and the capillary die.

FIG. 4 is a side view of a cleaning/packing rod.

FIG. 4a is an additional side view of the cleaning/packing rod wherein the rod is rotated 90° from the position depicted in FIG. 4 to show recesses 25.

FIG. 5 is a side view of the packing tip.

FIG. 6 is a side view of the cloth patch cleaning tip.

FIG. 7 is a side view of the cleaning brush.

FIG. 8 is a front view of the cleaning/packing rod as attached to the cleaning/packing linear motion device.

FIG. 9 is a view of the rod cap well, rod cap and pull-clip of the present invention in a disengaged position.

FIG. 10 is a view of the rod cap well, rod cap and pull-clip of the present invention in an engaged position.

FIG. 11 is a front view of a conventional rheometer having the capillary rheometer cleaning and packing device attached thereto wherein the housing is in the cleaning/packing position.

FIG. 12 is a front view of a conventional rheometer having the capillary rheometer cleaning and packing device attached thereto wherein the housing is in the testing position.

### DETAILED DESCRIPTION OF THE INVENTION

The present invention discloses a capillary rheometer cleaning and packing device 7 comprising: (a) a cleaning/packing linear motion device 9 for creating controlled linear motion in a linear motion rod 15, wherein the linear motion rod 15 is adapted to receive a cleaning/packing rod 20; (b) a housing cleaning/packing securing means 10 wherein the securing means is adapted to secure an existing capillary rheometer housing I to the cleaning and packing device 7 such that a barrel passage 29 mounted concentrically within the capillary rheometer housing 1 can be positioned and secured coaxially below the linear motion rod 15; and (c) a means of attaching the capillary rheometer cleaning and packing apparatus 7 to an existing capillary rheometer 36.

The present invention also discloses a capillary rheometer apparatus comprising: (a) a capillary rheometer frame 2; (b) a capillary rheometer housing I having an outer shell 3 1, a barrel 29 and a heating means, such as a heating coil 32, wherein the barrel passage 29 is located concentrically within the outer shell 31 and wherein the heating means 32 is located concentrically between the barrel 29 and the outer shell 31 and wherein the capillary rheometer housing 1 is movably mounted such that it may be moved to either a testing position (under the testing linear motion device 3) or a cleaning position (under the cleaning/packing linear motion device 9); (c) a capillary die 26 contiguous with the barrel 29; (d) a plunger adapted to fit within the bore of the housing barrel; (e) a means for driving the plunger longitudinally within the bore of the housing barrel; (f) a means for sensing the load applied by the plunger and a means for indicating the measured load, and a means for measuring the velocity of the plunger as it moves through the barrel; (g) a means of securing the housing in the testing position; and (h) a cleaning and packing device comprising: (i) a linear motion device for creating controlled linear motion in a linear motion rod, wherein the linear motion rod is adapted to receive a cleaning/packing rod; and (ii) a means of securing the housing in the cleaning position such that the housing barrel is positioned coaxially below the linear motion rod; wherein the cleaning and packing device is affixed to the frame.

The present invention further discloses a method of cleaning and packing the capillary rheometer described above comprising: (a) removing the capillary die secured to the bottom of the barrel; (b) securing the housing in a cleaning position wherein the barrel is positioned coaxially below the linear motion rod; (c) brushing the barrel with reciprocating motion provided by the linear motion device using a cleaning brush coaxially secured to a cleaning/packing rod, wherein the cleaning/packing rod is removably and coaxially secured to the linear motion rod; (d) cleaning the barrel with reciprocating motion provided by the linear motion device using a cloth patch cleaning tip coaxially secured to a cleaning/packing rod, wherein the cleaning/packing rod is removably and coaxially secured to the linear motion rod; (e) attaching the capillary die to the bottom of the barrel;; (f) pouring a polymer resin into the barrel and packing the polymer resin with reciprocating motion provided by the linear motion device using a packing tip coaxially secured to a cleaning/packing rod, wherein the cleaning/packing rod is removably and coaxially secured to the linear motion rod, and wherein the polymer resin may be added and packed repeatedly as needed until the barrel is filled to the desired amount; and (g) moving the housing to and securing it in the testing position.

Capillary rheometers are used in the polymer industry to establish shear and temperature related material properties and are known in the art. Any conventional capillary rheometer design which utilizes a force based plunger 4 and a barrel 29 may be adapted to include the cleaning and packing device of the present invention. Capillary rheometers generally operate by using the plunger 4 to force molten polymers that have been heated in the barrel passage 29 through a capillary die 26. A force sensor 3 measures the load or force applied to the plunger, and consequently to the polymer, and a displacement sensor measures the plunger's velocity through the stationary barrel. The shear viscosity of the melted polymer can then be determined using known relationships for flow of polymer melts through the capillary die of cylindrical or some other commonly used geometric design. The force applied by the plunger is generally created by a linear motion device 7. Such a linear motion device 7 may include electro hydraulic drives, electric servo motor drives, and electric pneumatic drives, or any other convention method of creating linear force. The means of measuring the load applied by the plunger may be any conventional technique of measuring the load or force applied by a linear motion device, including a force sensor which measures the force output of the linear motion device, or a pressure transducer which measures the pressure within the barrel.

Typical capillary rheometer designs include a frame 2, upon which the linear motion device 7, and the housing I are mounted. In conventional designs the housing 7 is pivotally mounted to the frame 2, and includes a securing means 8 that when actuated secures the housing 1 beneath the linear motion device 7 for testing. The pivotally mounted housing is normally swung out from under the linear motion device 7 for cleaning and packing. In the practice of this invention the housing is swung under the cleaning and packing device of this invention for cleaning and packing. Normally, the housing swings around a pivot point traveling along an arc in circular motion. However, the capillary rheometer can be designed in a manner wherein the housing is mounted to the frame in a manner that enables it to moved out from under the linear motion device 7 without traveling along an arc in circular motion. For instance, the housing can optionally be mounted to the frame in a manner whereby it can be move out from under the linear motion device 7 in a straight line. For instance, the housing could be mounted to the frame in a manner where it could be moved out from under the linear motion device to the front, to the side, diagonally, or in some other desired direction. This movement of the housing back and forth from the testing position to the cleaning/packing position can be powered by an electromotive device or can be accomplished by manually pushing the housing into the desired position. In one embodiment of this invention the movement from one position to the other can be provided by a screw drive that is powered by an electric motor.

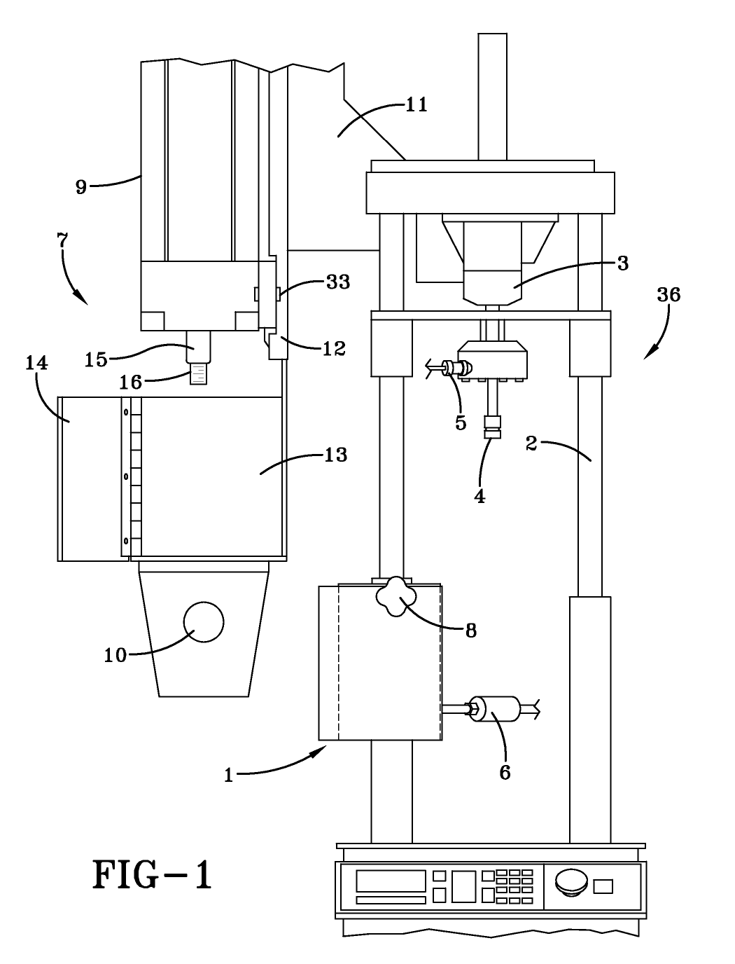

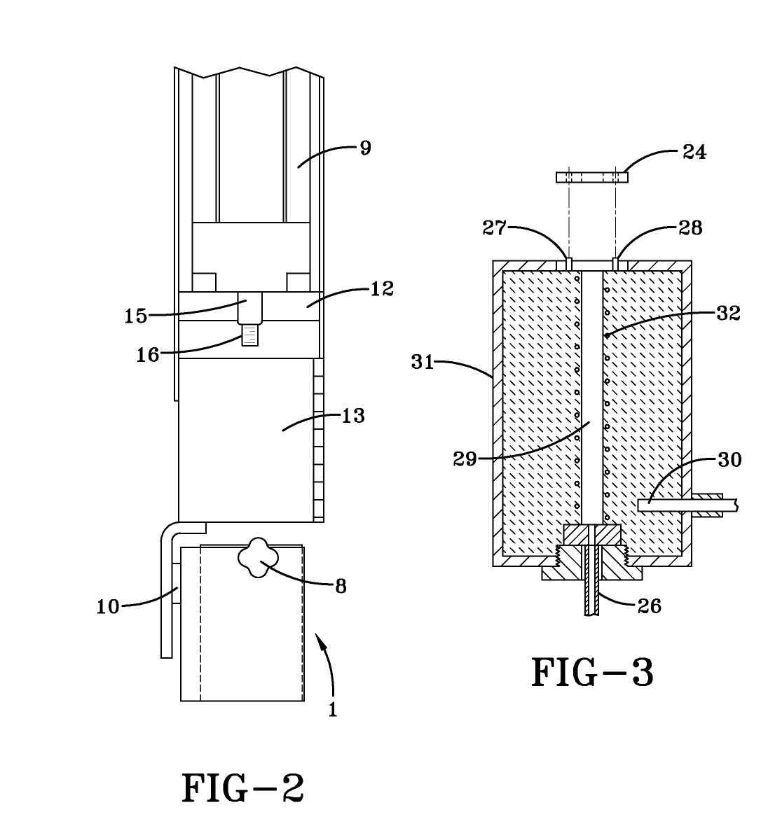

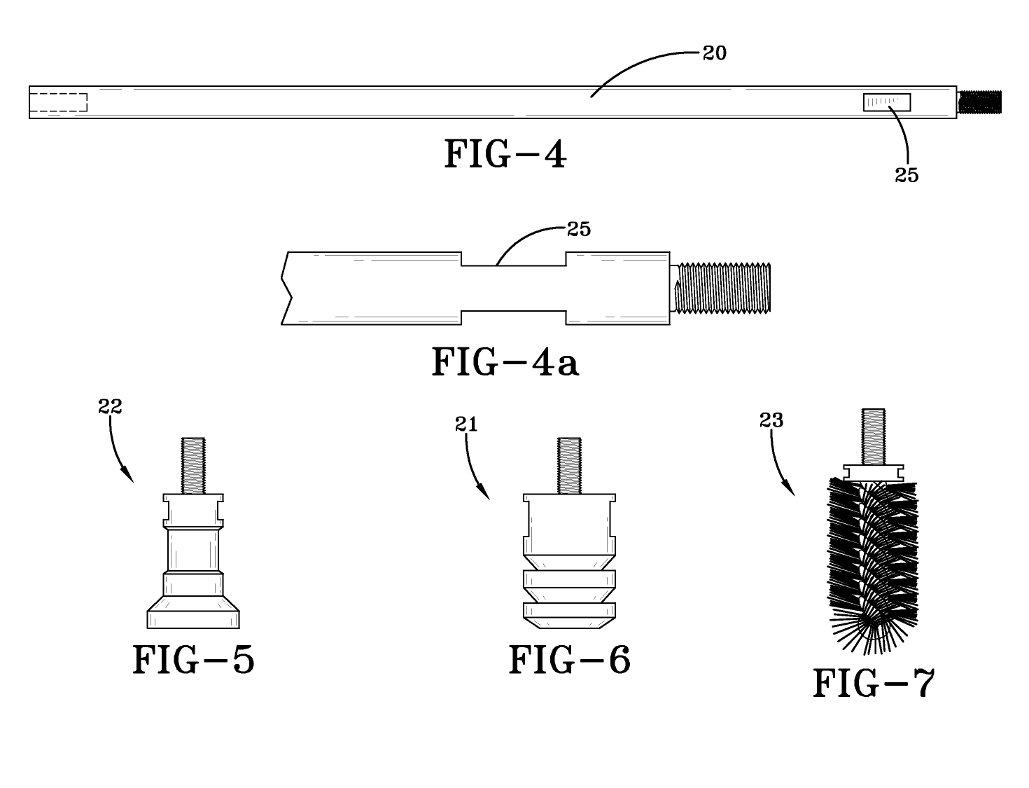

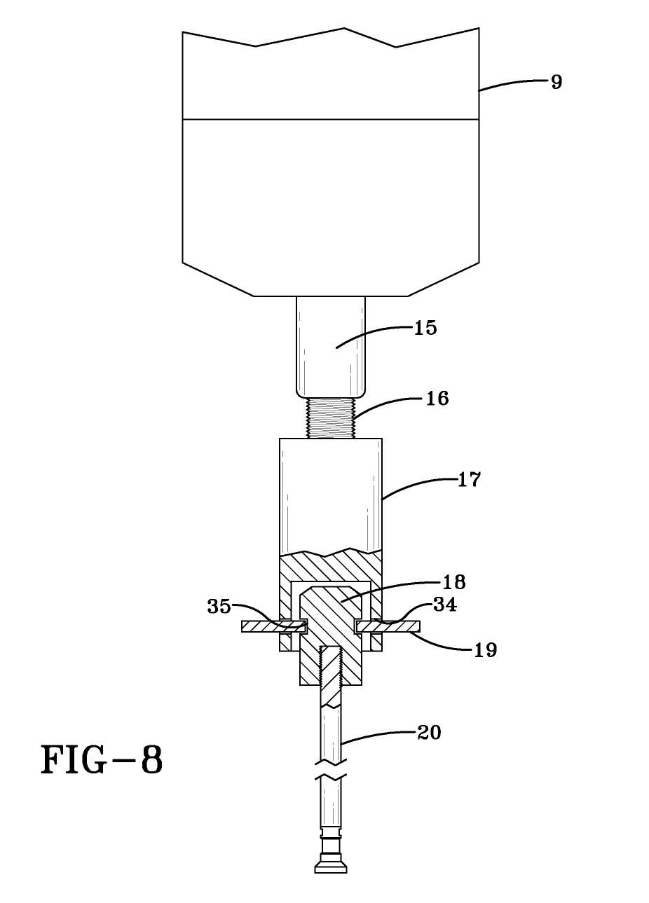

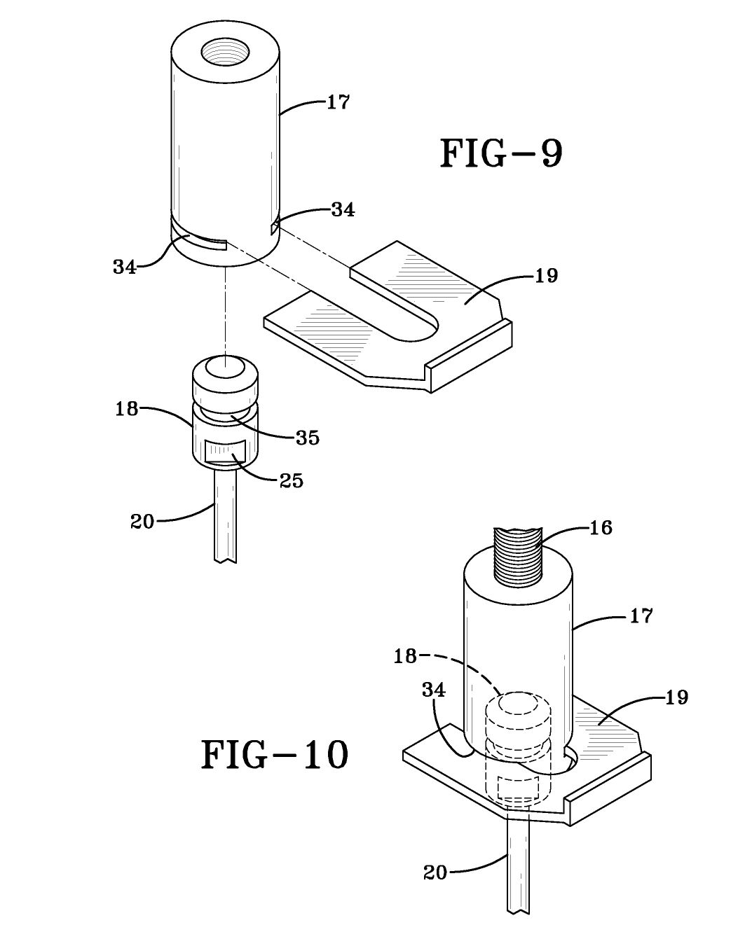

The securing means used to secure the housing for testing may be any conventional securing mechanism. The securing means shown in the embodiment in FIG. 1 is a captive screw in which a knob is turned to tighten or loosen the screw from a screw hole in the frame of the capillary rheometer. Referring to FIG. 3 the housing 1 includes an outer shell 31, a heating means 32, a barrel passage 29, and a capillary die 26. The outer shell forms a sturdy and resilient covering for the housing, and is typically made of a metal. The heating means used to heat the polymer resin within the barrel is typically a coil heating mechanism which generates heat by electrical current passing through the coil. In testing, the heating coil 32 heats the barrel passage 29 until the polymer reaches a desired temperature, as measured by a temperature sensing device 30. The polymer is heated to a temperature greater than it's melt temperature. Once heated, the polymer is subjected to pressure applied by the plunger and is forced through the capillary die 26. The capillary die 26 is removably secured into the bottom of the housing 1 contiguous with the barrel passage 29, such as by screwing the capillary die 26 into a threaded hole in the housing 1.

The cleaning and packing device of the present invention includes a linear motion device 9, a housing securing means 10, and a means of attaching the linear motion device to a capillary rheometer 11. The linear motion device 9 may be any conventional device known in the art for creating the needed linear motion. The linear motion device will, of course, need to provide the requisite packing load, velocity of the ram, acceleration rate, deceleration rate, and load hold times that are needed for cleaning and packing the. In other words, the linear motion device will need to be capable of providing the full array of linear motion that may be desired in clean and packing operation for all types of polymers that may be tested. The linear motion device will typically be controlled by a micro-processor that is programmed to carry out the desired actions For instance, the micro-processor will typically be capable of being programmed to provide desired cleaning/packing parameters. These controlled cleaning/packing parameters may include the speed of linear motion, acceleration, deceleration, the number of plunges, the duration cleaning and packing of cycles, timing between cycles, delays in operation for changing cleaning/packing rods, pressure applied in packing operations, and data entry. The automation of these functions can lead to a greater degree of reproducibility and consistent operation of the capillary rheometer.

Suitable linear motion devices for the capillary rheometer include electro hydraulic drives, electric servo motor drives, and electric pneumatic drives. An example of a suitable linear motion drive is the Parker Electro-Thrust Electric Cylinder. A servo-controller is used with the linear drive to provide e-limits and settings for the pattern of travel, i.e., length of travel, packing, cleaning and return- or end-positioning, and storage of these sequences for pre-setting of operation cycles. An example servo-controller is available from Parker Hannifin, part. No. GV6K-U3E-N/K, (Gemini™ GV6 Servo Drive/Controller) and also distributed by Cross Automation, 2001 Belmont Oaks Pkwy, Belmont N.C., 28012. The linear motion device is equipped with a linear motion rod 15 that is adapted to receive a cleaning and packing rod 20. In the preferred embodiment shown the tip of the linear motion rod 16 is threaded to allow an attachment to be screwed onto the linear motion rod. The linear motion device is mounted to a metal plate 12 that is itself secured to a mounting plate 11. The mounting plate 11 is adapted to be secured to the capillary rheometer. In the embodiment shown the mounting plate 11 is welded to the frame 2 of the capillary rheometer, and the metal plate 12 upon which the linear motion device is secured is welded to the mounting plate. This method of mounting ensures a solid and durable base for securing the cleaning and packing device; however, any known conventional method may be used to secure the device to the capillary rheometer. The linear motion device 9 is secured to the metal plate 12 by bolts 33.

In the preferred embodiment illustrated in the drawings the metal plate 12 that supports the linear motion device 9 extends below the linear motion rod 15 and supports a safety enclosure 13 that acts to protect a user from being injured by the cleaning and packing device. The safety enclosure 13 is closed on the sides and back, open on the top and bottom, and has a door 14 that can be opened to change parts, and closed during operation of the device. The door 14 is ideally made of a clear material, such as Lexan® fiberglass, so that it does not obstruct the user's view of the device while it is operating. The safety enclosure 13 is made of a strong, sturdy and durable material such as a metal and is attached to the metal plate 12.

The cleaning and packing device is equipped with a housing securing means 10 to secure the housing 1 in a cleaning and packing position beneath the safety enclosure 13. The securing means may be any conventional method known in the art capable of maintaining the housing in a stationary position. As shown in the drawings, the securing means of the preferred embodiment is a magnet. The magnet will typically be a rare earth magnet. The magnet 10 holds the metal outer shell 31 of the housing in position with magnetic forces high enough to ensure that normal operation of the cleaning and packing device will not cause the housing 1 to move. In this embodiment the magnet is affixed to a metal plate that is bolted to the safety enclosure.

In a preferred embodiment the cleaning/packing rod 20 is secured to the linear motion rod 15 by a rod cap 18, a rod cap well 17, and a pull-clip 19. The rod cap well 17 is cylindrical in shape, having a threaded hole on one closed end and an open cavity on the other. The rod cap well 17 screws onto the exposed end of the linear motion rod, with the cavity facing downwards. The rod cap well has two parallel slots 34 that create openings into the cavity of the rod cap well. The rod cap 18 is also cylindrical in shape and is of a diameter approximately equal to, but slightly less than, the diameter of the rod cap well cavity width. The rod cap 18 has a tapered end for insertion into the rod cap well and a threaded hole, opposite the tapered end, allowing it to be screwed onto the cleaning/packing rod 20. The rod cap 18 has a circular recess 35 around its perimeter corresponding to the parallel slots of the rod cap well 17. The pull-clip 19 is used to secure the rod cap 18 within the rod cap well 19. The pull-clip 19 is horse-shoe shaped with laterally spaced prongs. The prongs extend through the rod cap well slots 34 and the rod cap recess 35 thereby securing the components in position. This chuck and key design is similar to the one provided by the rheometer manufacturer to connect the push rod. However, the tolerance of the fit was reduced to hold better alignment of the rods to the bore.

In the preferred embodiment multiple cleaning/packing rods 20 are used, each with a different cleaning/packing tip, and each with a rod cap 18 secured to the opposite end of the cleaning/packing rod 20. In this way the pull-clip assembly may be used to quickly and easily change cleaning/packing tips as needed without the otherwise necessary screwing and unscrewing of various components of the device, which could become tedious and time consuming. Each cleaning/packing tip has a corresponding cleaning/packing rod with a rod cap attached. The cleaning/packing rods 20 may vary in length or design as needed to accommodate the different cleaning/packing tips. Each cleaning/packing rod is equipped with parallel tool recesses 25 near the end of the rod 20 opposite the rod cap 18, and each cleaning/packing tip is equipped with similar tool recesses 25. The tool recesses 25 allow a tool such as a wrench or pliers to be easily used when it is necessary to change the cleaning/packing tip. Although this method of securing the cleaning/packing rods 20 and tips is seen as the preferred embodiment, many variations or alternatives that would fall within the scope of the present invention would be obvious to a person skilled in the art.

In the preferred embodiment several cleaning/packing tips are used. A cleaning brush 23 is used to loosen any remaining polymer residue in the barrel passage 29 after testing has been performed. The cleaning brush 23 is adapted to be secured to a cleaning/packing rod 20. In this case the cleaning brush 23 is threaded on one end such that it may be screwed into a threaded hole located within an extreme end of the cleaning/packing rod 20. The brush 23 has metal bristles extending from a core piece that are slightly longer than the radius of the barrel passage 29 so that when the brush 23 is run through the barrel passage 29 force is applied on the walls of the passage to loosen residue. The brush 23 bristles will ideally be made of a material with a hardness less than that of the barrel passage 29 so that the bristles do not damage the barrel passage 29 walls.

A cloth patch cleaning tip 21 is used to remove loose polymer reside after the cleaning brush has been used. The cloth patch cleaning tip 21 is cylindrical in shape and is of a diameter slightly less than the diameter of the barrel passage 29. The cloth patch cleaning tip 21 is tapered on one end and has a threaded extension of a smaller diameter on the other for attaching the tip to the cleaning/packing rod. The cloth patch cleaning tip 21 also has at least one circular recess on its exterior which helps to keep a cloth patch wrapped around the tip 21 during cleaning.

A packing tip 22 is used to pack the polymer resin in the barrel passage 29 after the barrel passage 29 has been cleaned and prior to a subsequent test run. The packing tip 22 is cylindrical in shape with a smooth flat end for packing the polymer resin. The diameter of the smooth flat end of the packing tip 22 is approximately equal to but less than the diameter of the barrel passage 29. The packing tip 22 has a threaded extension with a smaller diameter opposite the packing end of the tip to allow the tip to be screwed into a threaded hole within an extreme end of the cleaning/packing rod 20.

In order to run a thermal viscosity test on a polymer using the capillary rheometer apparatus the capillary die 26 must first be secured into the bottom of the housing 1. Once the capillary die 26 is secured in the housing, the polymer resin is poured into the barrel passage 29 through the packing plate 24. The packing plate serves three functions. These functions include (1) better centering of the pack rod for insertion into the barrel, (2) keep the packing rod from hitting (and returning in error mode) on the ID step on the barrel of the rheometers (this is a significant problem when barrel is completely filled with polymer which is usually the case in normal operation of the rheometer), and (3) cleaning the molten polymer off the tip of the pack rod when it is removed from the bore. After a predetermined amount of polymer resin has been poured into the barrel (typically the barrel is filled completely), the cleaning and packing device is used to pack the polymer resin in the barrel passage 29. The polymer resin may be added and packed multiple times until the barrel passage is filled to a desired level with uniformly packed polymer resin. The housing 1 is then moved to the testing position and secured in place so that it cannot move. The polymer resin is then heated in the barrel passage by the heating means to a temperature greater than its melt point. The melted polymer resin is subjected to pressure applied by the plunger 4 and linear motion device 3 to force the polymer through the capillary die 26. By measuring the velocity of the plunger 4 through the barrel passage as pressure is applied to the melted polymer the thermal properties of the polymer can then be determined.

After testing is complete the capillary die 26 is removed from the housing. The housing is moved to the cleaning position and secured in place. While in the cleaning position the barrel passage 29 is first brushed with the cleaning brush 23 using reciprocating motion, and then cleaned with the cloth patch cleaning tip 21 using reciprocating motion. In order to clean with the cloth patch cleaning tip 21, a cloth patch is positioned over the barrel bore and the patch cleaning rod with tip 21 is pushed down into the bore, folding the patch around the tip of the rod. The cloth patch cleaning tip 21 and the cloth patch are then pushed through the barrel passage 29 by the linear motion device 9, thereby removing the polymer residue loosened by the cleaning brush 23. After the barrel passage has been cleaned with the cloth patch cleaning tip 21 the capillary die 26 may be placed back in the housing 1 and the process of testing and cleaning repeated.

This invention is illustrated by the following examples that are merely for the purpose of illustration and are not to be regarded as limiting the scope of the invention or the manner in which it can be practiced. Unless specifically indicated otherwise, parts and percentages are given by weight.

### COMPARATIVE EXAMPLE 1

In this experiment a conventional capillary rheometer was used to determine the melt viscosity of a thermoplastic resin utilizing a prior art technique. In the procedure used the capillary rheometer was cleaned by first unscrewing the capillary die from the bottom of the rheometer housing with a wrench. A stiff rod was pushed through the capillary of the die after it was removed from the rheometer housing to force any residual polymer from the prior test run out of the die capillary.

The rheometer housing was then unlocked from being in the test position under the pressure/load sensor, as shown in FIG. 12, and was swung into the cleaning/packing position away from the pressure/load sensor, as depicted in FIG. 1. A wire brush was plunged through the barrel of the rheometer 6 to 8 times. Then, a cloth gun cleaning patch was plunged through the barrel of the rheometer for an additional 6 to 8 times. At that point the capillary die was screwed back into the bottom of the rheometer housing. The barrel of the rheometer was then filled with a powder of the thermoplastic polymer being tested. A packing rod was then used to manually compact the thermoplastic material into the barrel of the device. Then, the top of the barrel was again filled with additional polymer powder and manually compacted into the barrel with the procedure being repeated until the barrel was full of compacted polymer powder.

The rheometer housing was then swung back into the test position and locked into position for testing. The polymer powder was heated to above its melting point in the barrel of the rheometer and forced through the rheometer die to test its melt viscosity. The conventional rheometer cleaning, packing, and testing procedure was then repeated. The technician that used this procedure reported it to be a time consuming and physically exhausting endeavor of a repetitive nature. In using the conventional rheometer the technician needed to force the cleaning brush and cloth gun cleaning patch through the barrel of the rheometer from awkward positions. This was particularly burdensome in the case of packing the rheometer with polymer because it is necessary to exert a substantial amount of force to properly pack the barrel of the rheometer. It should be noted that high molecular weight polymers normally require the highest level of force to be properly packed. Packing such polymers from awkward positions can be extremely tiring. .

### EXAMPLE 2

In this experiment a capillary rheometer that was equipped with the cleaning and packing attachment of this invention was used to determine the melt viscosity of a thermoplastic resin. In the procedure used the capillary rheometer was cleaned by first unscrewing the capillary die from the bottom of the rheometer housing with a wrench. A stiff rod was pushed through the capillary of the die after it was removed from the rheometer housing to force any residual polymer from the prior test run out of the die capillary.

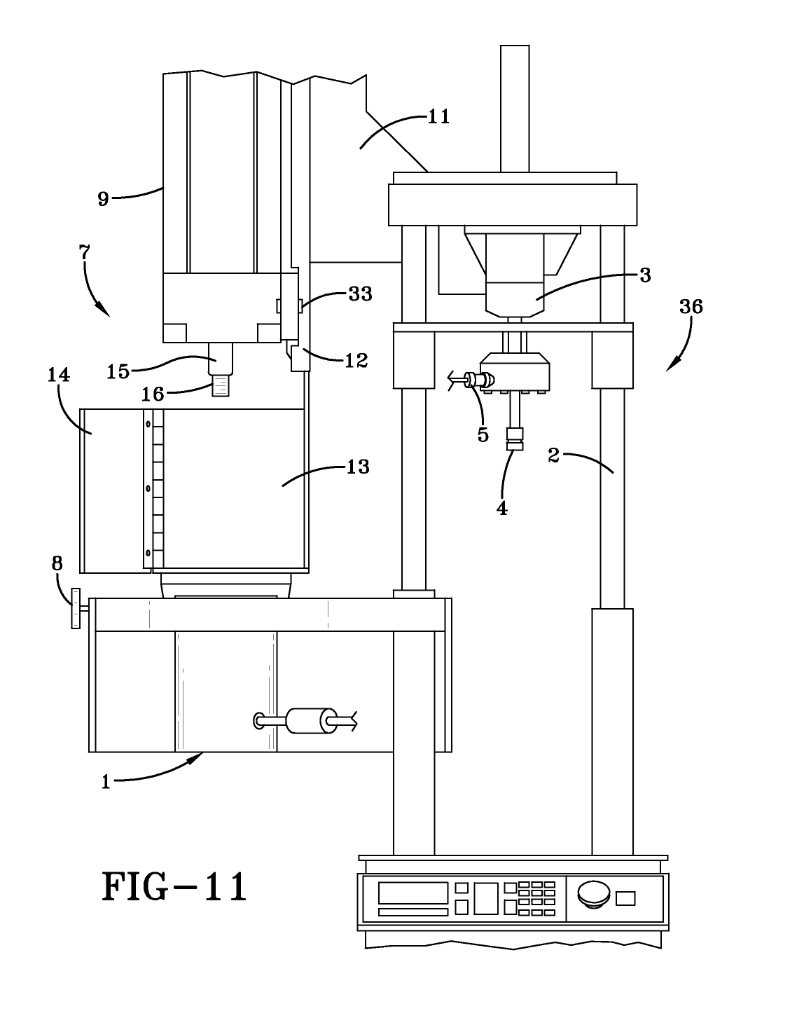

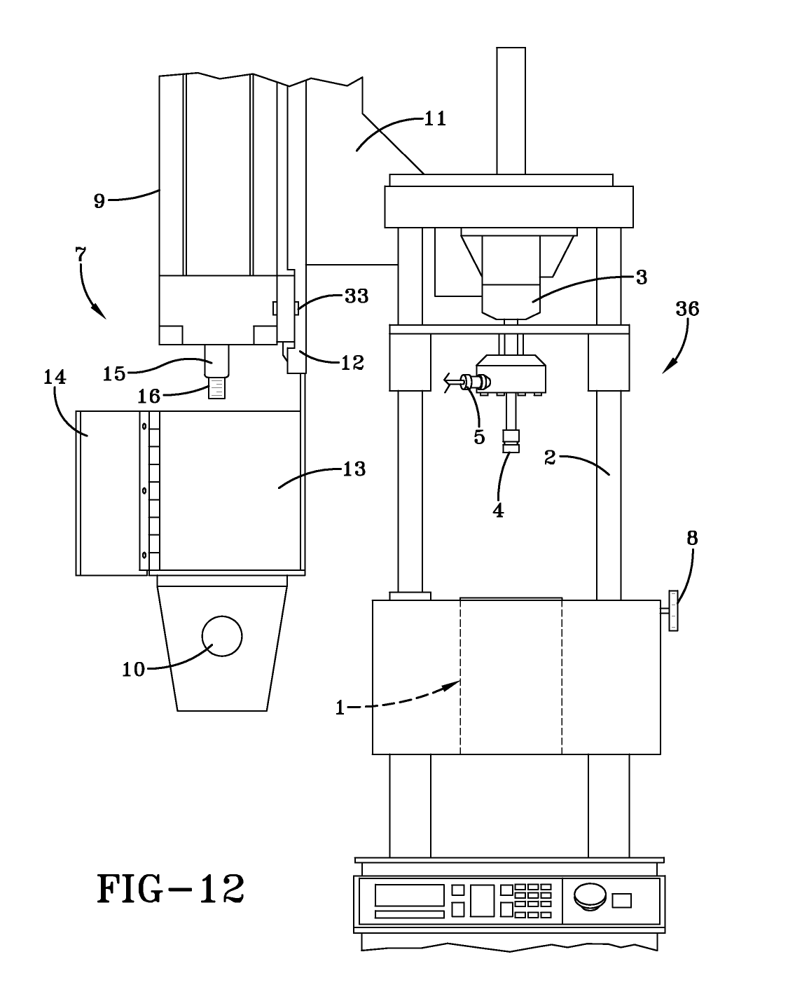

The rheometer housing was then unlocked from being in the test position under the pressure/load sensor as illustrated in FIG. 12, and was swung into the cleaning/packing position under the linear motion device of the cleaning/packing attachment as depicted in FIG. 11. The rheometer housing was held in the cleaning/packing position by the magnet on the cleaning and packing attachment (the cleaning/packing securing means 10 shown in FIG. 1).

A cleaning/packing rod having a cleaning brush attached to its end was then attached to the linear motion rod attachment means utilizing a pull clip to facilitate easy attachment. The automated cleaning/packing device was then used to plunge the cleaning brush through the barrel of the rheometer 6 to 8 times. Then, the cleaning/packing rod with the brush tip was removed from the linear motion rod attachment by simply removing the pull clip therefrom. A cleaning/packing rod was then attached to the linear motion rod attachment again utilizing the pull clip for easy attachment. A cloth gun cleaning patch was then plunged through the barrel of the rheometer 6 to 8 times.

The pull clip was removed and the cleaning/packing rod with the cloth gun cleaning patch was then disengaged from the device and replace with a cleaning/packing rod having a packing plate prong. The cleaning/packing rod having the packing plate prong was securely attached to the linear motion rod attachment using the pull clip. The capillary die was screwed back into the bottom of the rheometer housing. The barrel of the rheometer was then filled with a powder of the thermoplastic polymer being tested. The polymer powder was then compacted into the barrel of the rheometer with the packing plate prong. Then, the top of the barrel was again filled with additional polymer powder and again was compacted into the barrel with the procedure being repeated until the barrel was full of compacted polymer powder.

The rheometer housing was then swung back into the test position and locked into position for testing. The polymer powder was heated to above its melting point in the barrel of the rheometer and forced through the rheometer die to test its melt viscosity. This improved rheometer cleaning, packing, and testing procedure was then repeated. The technician that used this procedure reported it to be far less time consuming and that it required much less physically exertion than did the prior art technique. The automated procedure of this invention also resulted in the barrel of the rheometer being more consistently packed with polymer powder which should lead to more consistent test results.

### EXAMPLE 3

In this experiment the prior art method of cleaning and packing a rheometer (as described in Example 1) was compared to the method of cleaning and packing a rheometer which utilizes the method and equipment of this invention (as described in Example 2). In the procedures used the melt viscosity of identical Fortron® polyphenylene sulfide (PPS) samples was determined using both methods. More specifically, three operators (technicians) made viscosity determinations on 5 lots of the PPS samples with the procedure being repeated in a second trial. The results of this comparison are reported in Table 1.

TABLE 1

| | Standard | Study | % Study | % |
|---|---|---|---|---|
| Procedure of Example | Deviation | Variation | Variation | Tolerance |
| 1 (Prior Art Method) | 1.35622 | 6.9845 | 34.32 | 58.2 |
| 2 (Method of Invention) | 1.04825 | 5.3985 | 28.8 | 44.99 |

As can be seen by reviewing the data reported in Table 1, more consistent results were attained by using the equipment and procedure of this invention than was attained using the prior art equipment and method. Accordingly, utilizing the equipment and procedure of this invention leads to higher accuracy and more consistent results.

While certain representative embodiments and details have been shown for the purpose of illustrating the subject invention, it will be apparent to those skilled in this art that various changes and modifications can be made therein without departing from the scope of the subject invention.

What is claimed is:

1. A capillary rheometer cleaning and packing device comprising: (a) a linear motion device for creating controlled linear motion in a linear motion rod, wherein the linear motion rod is adapted to receive a cleaning/packing rod; (b) a housing securing means wherein the securing means is adapted to secure an existing capillary rheometer housing to the cleaning and packing device such that a barrel mounted concentrically within the capillary rheometer housing is positioned coaxially below the linear motion rod; and (c) a means of attaching the capillary rheometer cleaning and packing apparatus to an existing capillary rheometer.

2. The capillary rheometer cleaning and packing device as specified in claim 1 wherein the linear motion device is an electric servo motor drive.

3. The capillary rheometer cleaning and packing device as specified in claim 1 wherein the cleaning/packing rod is adapted to be secured to the linear motion rod by a rod cap well and a rod cap, wherein the rod cap well is secured to the exposed tip of the linear motion rod and the rod cap is secured to an extreme end of the cleaning/packing rod and wherein the rod cap well is cylindrical having a concentric cylindrical cavity disposed therein and wherein the extreme end of the cavity is open and wherein the rod cap well is equipped with parallel slots within the portion of the rod cap well defining the cylindrical cavity and wherein the rod cap is cylindrical and has a diameter approximately equal to but less than the diameter of the cylindrical cavity of the rod cap well and wherein the rod cap is equipped with a cylindrical recess corresponding to the parallel slots of the rod cap well such that the rod cap mounts within the cylindrical cavity of the rod cap well and is secured therein by a pull clip, wherein the pull clip has two laterally spaced parallel prongs that insert through the parallel slots of the rod cap well and the cylindrical recess of the rod cap thereby securing the rod cap within the rod cap well.

4. The capillary rheometer cleaning and packing device as specified in claim 1 wherein the securing means is a magnet mounted such that the capillary rheometer housing's outer shell is secured to the magnet by the magnetic forces acting on the outer shell.

5. A capillary rheometer apparatus comprising: (a) a frame; (b) a housing having an outer shell, a barrel and a heating means wherein the barrel is located concentrically within the outer shell and wherein the heating means is located concentrically between the barrel and the outer shell and wherein the housing is movably mounted such that it may be moved to either a testing position or a cleaning position; (c) a capillary die contiguous with the barrel; (d) a plunger adapted to fit within the bore of the housing barrel; (e) a means for driving the plunger longitudinally within the bore of the housing barrel; (f) a means for sensing the load applied by the plunger and a means for indicating the measured load, and a means for measuring the velocity of the plunger as it moves through the barrel; (g) a means of securing the housing in the testing position; and (h) a cleaning and packing device comprising: (i) a linear motion device for creating controlled linear motion in a linear motion rod, wherein the linear motion rod is adapted to receive a cleaning/packing rod; and (ii) a means of securing the housing in the cleaning position such that the housing barrel is positioned coaxially below the linear motion rod; wherein the cleaning and packing device is affixed to the frame.

6. The capillary rheometer apparatus as specified in claim 5 wherein the cleaning and packing device is further comprised of a safety enclosure into which the linear motion rod extends during cleaning and packing of the barrel.

7. The capillary rheometer apparatus as specified in claim 6 wherein the safety enclosure has a door that can be closing during operation of the cleaning and packing device.

8. The capillary rheometer apparatus as specified in claim 5 wherein the means for driving the plunger includes an electric servo motor drive.

9. The capillary rheometer apparatus as specified in claim 5 wherein the heating means is an electrical resistance coil.

10. The capillary rheometer apparatus as specified in claim 5 wherein the means of securing the housing in the cleaning position is a magnet mounted such that the outer shell of the housing is secured to the magnet by magnetic forces, and wherein the outer shell is made of a ferromagnetic material.

11. The capillary rheometer apparatus as specified in claim 5 wherein the means of securing the housing in the testing position is a captive screw.

12. The capillary rheometer apparatus as specified in claim 5 wherein the means for sensing the load applied to the plunger is a pressure transducer.

13. A capillary rheometer test kit comprising: the capillary rheometer apparatus as specified in claim 5; at least one cleaning/packing rod wherein the cleaning/packing rod is adapted to be removably and coaxially secured to the linear motion rod; and at least one cleaning/packing tip wherein the cleaning/packing tip is adapted to be removably and coaxially secured to the cleaning/packing rod.

14. The capillary rheometer test kit as specified in claim 13 wherein the at least one cleaning/packing tip includes a cleaning brush.

15. The capillary rheometer test kit as specified in claim 13 wherein the at least one cleaning/packing tip includes a cloth patch cleaning tip.

16. The capillary rheometer test kit as specified in claim 13 wherein the at least one cleaning/packing tip includes a packing tip.

17. The capillary rheometer test kit as specified in claim 13 wherein the at least one cleaning/packing rod is cylindrical and wherein the cleaning/packing rod is equipped with parallel recesses located approximately at the extreme end of the cleaning/packing rod nearest the cleaning/packing tip.

18. The capillary rheometer test kit as specified in claim 13 further comprising a rod cap well and at least one rod cap, wherein the rod cap well is cylindrical having a concentric cylindrical cavity disposed therein, and wherein the extreme end of the cavity is open, and wherein the rod cap well is equipped with parallel slots within the portion of the rod cap well defining the cylindrical cavity, and wherein the at least one rod cap is cylindrical and has a diameter approximately equal to but less than the diameter of the cylindrical cavity of the rod cap well, and wherein the at least one rod cap is equipped with a cylindrical recess corresponding to the parallel slots of the rod cap well such that the at least one rod cap mounts within the cylindrical cavity of the rod cap well and is secured therein by a pull clip, wherein the pull clip has two laterally spaced parallel prongs that insert through the parallel slots of the rod cap well and the cylindrical recess of the rod cap thereby securing the rod cap within the rod cap well.

19. A method of cleaning and packing the capillary rheometer apparatus specified in claim 5 comprising: (a) removing the capillary die secured to the bottom of the barrel; (b) securing the housing in a cleaning position wherein the barrel is positioned coaxially below the linear motion rod; (c) brushing the barrel with reciprocating motion provided by the linear motion device using a cleaning brush coaxially secured to a cleaning/packing rod, wherein the cleaning/packing rod is removably and coaxially secured to the linear motion rod; (d) cleaning the barrel with reciprocating motion provided by the linear motion device using a cloth patch cleaning tip coaxially secured to a cleaning/packing rod, wherein the cleaning/packing rod is removably and coaxially secured to the linear motion rod; (e) attaching the capillary die to the bottom of the barrel;; (f) pouring a polymer resin into the barrel and packing the polymer resin with reciprocating motion provided by the linear motion device using a packing tip coaxially secured to a cleaning/packing rod, wherein the cleaning/packing rod is removably and coaxially secured to the linear motion rod, and wherein the polymer resin is added and packed repeatedly as needed until the barrel is filled to the desired amount; and (g) moving the housing to and securing it in the testing position.

20. A method of cleaning and testing a polymer with the capillary rheometer apparatus specified in claim 5 comprising: (a) attaching the capillary die to the bottom of the barrel; (b) pouring a polymer resin into the barrel and packing the polymer resin with reciprocating motion provided by the linear motion device using a packing tip coaxially secured to a cleaning/packing rod, wherein the cleaning/packing rod is removably and coaxially secured to the linear motion rod, and wherein the polymer resin is added and packed repeatedly as needed until the barrel is filled to the desired amount; (c) moving the housing to and securing it in the testing position; (d) heating the polymer resin to a desired temperature greater than its melting point within the barrel; (e) applying a desired pressure to the molten polymer using the plunger, thereby forcing the polymer through the capillary die; (f) determining the shear viscosity of the polymer; (g) removing the capillary die secured to the bottom of the barrel; (h) moving the housing to and securing it in a cleaning position wherein the barrel is positioned coaxially below the linear motion rod; (i) brushing the barrel with reciprocating motion provided by the linear motion device using a cleaning brush coaxially secured to a cleaning/packing rod, wherein the cleaning/packing rod is removably and coaxially secured to the linear motion rod; (j) cleaning the barrel with reciprocating motion provided by the linear motion device using a cloth patch cleaning tip coaxially secured to a cleaning/packing rod, wherein the cleaning/packing rod is removably and coaxially secured to the linear motion rod.
